(19) United States
(12) Patent Application Publication
(10) Pub. No.: US 2003/0061152 A1
(43) Pub. Date: Mar. 27, 2003

(54) System and method for determining Value-at-Risk using FORM/SORM

(76) Inventors: Rabi S. De, Bellaire, TX (US); Tanya Tamarchenko, Bellaire, TX (US)

Correspondence Address: Stuart J. ford, VINSON & ELKINS LLP, 2300 First City Tower, 1001 Fannin Street, Houston, TX, 77002-6760, US

(21) Appl. No.: 09/964,299

(22) Filed: Sep. 26, 2001

(51) Int. Cl. G06F 17/60

(52) U.S. Cl. 705/38

(57) ABSTRACT

A system and method are presented for the determination of Value-at-Risk (VAR) and other tail-risk measures for a portfolio of derivative securities. The present invention determines the tail of the probability distribution of portfolio returns based on first- and second order structural reliability (FORM/SORM) methods. As used herein, the present inventive method is referred to as “Reliability VAR.” The inventive system and method of calculating VAR is not restricted to representation of positions in a portfolio as “delta-gamma” sensitivities to the underlying price returns. Additionally, the inventive system and method lends itself to the determination of VAR in the presence of underlying price returns with so-called “fat tails.” In particular, a probability preserving transformation using a Hermite-model based correlation-mapping technique, previously used only in structural reliability analysis, has been applied to transform the VAR-related probability-estimation problem with non-Gaussian risk factors to an equivalent probability estimation problem in the standard Gaussian space.

### BACKGROUND OF THE INVENTION

1. Field of the Invention

The present invention relates to systems and methods for determining financial risk, and more particularly to determining value at risk for a portfolio of derivative securities.

2. Description of the Related Art

Increased volatility in financial markets has spurred development of probabilistic measures of portfolio risk arising out of adverse price movements. Value-at-Risk (VAR), by-far the most popular among such measures, answers the question: “How much money might one lose over a given time horizon with a given small probability assuming that the portfolio does not change?” Calculation of VAR and related risk measures, such as the Expected Tail Loss, require accurate estimation of the lower tail of the return distribution. Practical implementation of such tail-risk measures for a trading portfolio calls for making assumptions about the form of the underlying price processes and the payoff equations of the underlying instruments. One standard approach, known as Monte Carlo method, is to simulate prices of the underlying instruments over a specified time horizon, calculate the portfolio value for each set of simulated prices, and obtain a distribution of changes in portfolio value. Typically a large number of simulations is required to reliably estimate tail probabilities. As a result, simulating additional risk measures such as the Expected Tail Loss may become impractical, especially if the portfolio payoff is a function of a large number of price returns, is expensive to evaluate, and/or the return distribution is fat-tailed (leptokurtic).

The Analytical VAR approach suggested by D. Duffie and J. Pan, in their paper “Analytical Value-At-Risk with Jumps and Credit Risk,” overcomes this difficulty by using a fast convolution technique, but the framework requires that the portfolio be represented by its delta-gamma sensitivities to underlying price returns and the non-Gaussianity of price returns, if any, be modeled through discrete jumps. In contrast, the present inventive system and method is not constrained by a delta-gamma representation of derivative positions and is capable of treating price returns that are specified by their non-Gaussian (fat-tailed) distributions. For many portfolios delta-gamma representations are inadequate for capturing tail risk.

### BRIEF SUMMARY OF THE INVENTION

The present invention provides a system and method for determining financial risk, and more particularly to determining value at risk for a portfolio of derivative securities. The present invention determines the tail of a probability distribution of portfolio value changes (profit and loss) using first- and second order structural reliability (FORM/SORM) methods. As used herein, the present inventive method is referred to as “Reliability VAR.” The inventive system and method of calculating VAR is not restricted to representation of positions in a portfolio as “delta-gamma” sensitivities to the underlying price returns. Additionally, the inventive system and method lends itself to the determination of VAR in the presence of non-Gaussian price returns, i.e., underlying price returns with so-called “fat tails.” In particular, a probability preserving transformation using a Hermite-model based correlation-mapping technique, previously used only in structural reliability analysis, has been applied to transform the VAR-related probability-estimation problem with non-Gaussian price returns to an equivalent probability estimation problem in the standard Gaussian space.

The underlying probability framework (FORM/SORM) of the present invention is capable of treating correlated non-Gaussian distribution of price returns as well as any “reasonably regular” non-linear portfolio payoff function. Unlike a Monte Carlo simulation, the computational burden in FORM/SORM does not increase for low probability events. Unlike numerical integration techniques, the computational burden in FORM/SORM is relatively insensitive to the increase in the number of underlying price returns considered.

The inventive system and method produce faster and more accurate results compared to standard techniques of calculating VAR. The inventive system and method determines a probability preserving transformation between a set of correlated price returns of one or more financial instruments and of standard Gaussian variates from a probability model for the price returns; creates a set of loss (negative portfolio value change) threshold values at which a lower tail of a probability distribution of portfolio value change is to be evaluated; selects a value from the set of loss threshold values; determines in the standard Gaussian space, a limit-state surface on which the portfolio value change is equal to the selected loss threshold value by expressing a limit-state-equation (portfolio value change=selected loss threshold value) in terms of one or more standard Gaussian variates using the probability preserving transformation; finds one or more “design points” on the limit-state surface that are closest to an origin of a standard Gaussian space; determines a probability of portfolio value change not exceeding the selected loss threshold value using First-Order Reliability Method, Second-Order Reliability Method, or importance sampling around the one or more design points, or combination thereof; repeats steps for each selected loss threshold whereby a lower tail of the cumulative probability distribution of portfolio value change is created; and determines a Value-at-Risk as a desired quantile of the lower tail of the cumulative probability distribution of portfolio value change. If desired, the expected tail loss may be calculated by integrating the lower tail of the cumulative probability distribution of portfolio value change below the desired quantile.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a diagram depicting FORM/SORM concepts: limit-state surface, design point and linear approximation at the design point;

FIG. 2 is a flow diagram describing a summary of the steps performed in the VAR determination of the inventive method and system;

FIG. 3 is a chart showing Performance of “Reliability” VAR method in estimating the tail of portfolio value change distribution;

FIG. 4 is chart showing comparative efficiency of design-point importance sampling and ordinary Monte-Carlo (brute force) simulation;

FIG. 5 is a chart showing a comparison of different methods of calculating the tail of the probability distribution for a portfolio of hedged instrument with a highly nonlinear payoff function

FIG. 6 is a chart showing the use of Reliability VAR in the presence of “fat-tailed” price returns.

### DETAILED DESCRIPTION OF THE INVENTION

I. Description of Underlying Framework

To illustrate the basic idea behind Reliability VAR, assume that a portfolio exists of stocks and options on stocks. The probability model for the portfolio value change, dΠ, over time horizon τ can be written as follows:

$$d Π = {\sum }_{i = 1}^{n} {N}_{i} {c}_{i} ( {S}_{i} ) - {Π}_{0} , \qquad ( 1 )$$

where Nᵢ is the quantity (number) of the i^{th} derivative instrument on stock i, Sᵢ is the underlying stock price at time τ, cᵢ (Sᵢ) is the value of the i^{th} derivative position as a function of the underlying stock price, Π₀ is the initial value of the portfolio, and n is the total number of different instruments in the portfolio.

Next the portfolio value-change (profit or loss) function is expressed as a function of standard Gaussian variates. Standard Gaussian variates have zero means, unit standard deviations, and are independent of each other, i.e., have zero pair-wise correlation.

I.1 Representing Portfolio Value Change as a Function of Standard Gaussian Variates

Following the standard practice, the underlying stock prices are assumed to be have log-normal probability distributions, which are specified by drifts [μ=μ₁, μ₂, . . . μₙ]^{T} and an n-by-n variance-covaniance matrix C of the corresponding price log-returns, which are normally distributed. For the case of lognormal prices, the transformation to represent the portfolio value change as a function of standard Gaussian variates is well documented in the literature. The transformation is presented below in order to introduce terminology and notations used throughout the text. The transformation if one or more underlying price returns are non-Gaussian is described later in this text.

Following the standard practice, the covariance matrix C is factorized. In one embodiment, “Jacobi transformation” is used to obtain an n-by-k (where k≦n) matrix J such that C=J·J^{T}. Note that k is less than n if some of the price returns are perfectly correlated. The random stock price Sᵢ at time τ is then expressed as a function of the starting price Sᵢ₀ at time zero and a set of standard Gaussian variates, U₁, U₂, . . . , Uₖ, as follows:

$${S}_{i} = {S}_{i0} {ⅇ}^{{μ}_{i} τ + {ξ}_{i} \sqrt{τ}} , where {ξ}_{i} = {\sum }_{m = 1}^{k} {J}_{im} {U}_{m} \qquad ( 2 )$$

Equations (1) and (2) together express the portfolio loss, dΠ, as a function of k standard Gaussian variables, which are transformed risk factors for the portfolio.

I.2 Formulation of the VAR Problem in the Reliability VAR Framework

For the VAR problem, one is interested in finding the portfolio value change v (with negative value signifying loss) corresponding to a small probability of non-exceedance q (=1−p, where p is the VAR confidence level) such that:

P{dΠ<v}=q (3)

Instead of finding v for a specified probability q, in the inventive system and method, the inverse problem is solved, i.e., the probability q is calculated for a given loss threshold v. The inverse problem is solved for a range of different v values covering a desired range of the lower tail of dΠ distribution. In general, the range of loss threshold is selected by trial and error to cover a desired range of low non-exceedance probability levels, e.g., 10⁻⁵ to 10⁻¹. In one embodiment, the following scheme is used to determine the range of loss threshold values:

1. use a “Variance-Covariance” method to estimate a standard deviation of portfolio value change based on “delta” sensitivities of the underlying options, current market prices, volatilities and correlation; and

2. set a range of loss threshold from minus 5 standard deviations to minus 1 standard deviation; and

3. select 100 equally spaced (in logarithmic scale) loss thresholds inside selected range.

A level surface defined by dΠ=v in R^{k} is referred to as the limit-state surface. Points on the limit-state surface represent states of risk factors that produce the same specified value change (loss) v. The equation dΠ−v=0 is referred to as the “limit-state equation” in the structural reliability literature and is generically denoted as:

G(u₁,u₂, . . . uₖ)=0; or more generally G(u₁,u₂ . . . uₖ;v)=0 (4)

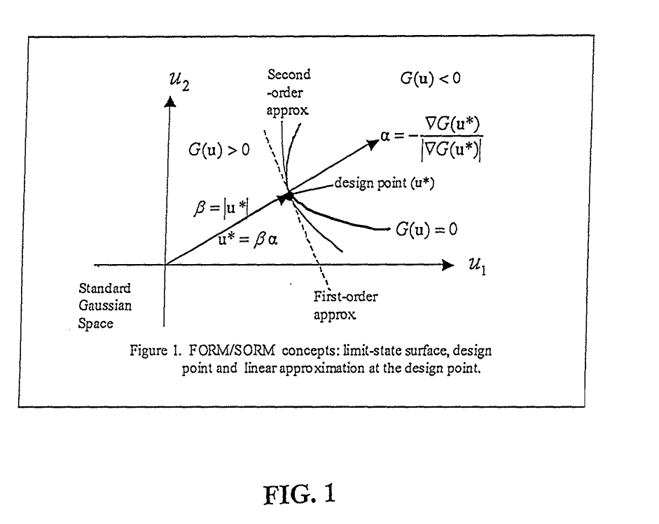

Clearly the function G(.) depends on the specified loss threshold, v, and is referred to as the limit-state function. FIG. 1 illustrates the concept of limit-state surface in a two-dimensional Gaussian space. All points on the line G(u)=0 represent pairs of risk factor values (u₁, u₂) that produce the same loss value.

Probability of loss q is obtained by integrating φ_{U}(.), the probability density function of standard Gaussian variates, U₁, U₂, . . . , Uₖ, over the loss region, denoted by dΠ<v:

$$q = {\int \int \int }_{d Π < v} {φ}_{{U}_{1} , {U}_{2} , … , {U}_{k}} ( {u}_{1} , {u}_{2} , … , {u}_{k} ) ⅆ {u}_{1} ⅆ {u}_{2} … ⅆ {u}_{k} = {\int }_{G ( u ) < 0} {φ}_{U} ( u ) ⅆ u \qquad ( 5 )$$

The first and second-order reliability method (FORM/SORM) is essentially a fast and efficient probability integration technique to estimate the probability content of the loss region bounded by the limit-state surface. Central to the FORM/SORM methodology is the concept of “design point,” which is described below. The inventive system and method performing FORM/SORM methodology includes the following steps:

1. Determine the “design point” by solving the first-order reliability problem. “Design point” is a point on the limit-state surface closest to the origin in the standard Gaussian (u-) space, distance of which from the origin yields a FORM estimate of the probability of portfolio value change not exceeding the loss threshold.

2. If desired, use a second-order approximation of the limit-state surface at the “design point” to calculate an improved estimate of the loss probability.

3. Alternatively, apply importance sampling at the design point to efficiently estimate the loss probability.

3. Determine multiple design points, if they exist.

4. Add probability contribution from multiple “design points”, if any, using series system methodology.

I.3 Determination of “Design Point”

The standard Gaussian space is rotationally symmetric and the probability density φ_{U}(u) tapers off exponentially with the square of the distance of the point u from the origin. Therefore, the largest contribution to the integral in Equation (5) comes from the vicinity of u*, a point on the limit-state surface that is the closest to the origin (see FIG. 1), referred to as the “design point” in structural-reliability literature. The design-point coordinates represent the most-likely-to-occur states of the risk factors that cause the portfolio loss to be equal to the selected threshold v. The direction cosines of the gradient vector α at the design point (see FIG. 1) represent sensitivities of the loss probability with respect to various risk factors. Neither Monte-Carlo, nor numerical integration techniques yield these important pieces of information often sought by risk managers to facilitate portfolio hedging and VAR management.

The design point is found by solving a constrained optimization problem: minimize |u|, subject to G(u)=0. In one embodiment, the coordinates of the “design point” are calculated using a simple iterative procedure based on the fact that at the “design point” u*, the gradient of the function G(u*) is collinear with vector u* (see FIG. 1). In its simplest form, the algorithm finds a sequence of vectors u^{(m)}, each one calculated as follows:

$$\begin{matrix}{u}^{( m + 1 )} = [ ( {u}^{( m )} \cdot {α}^{( m )} ) + \frac{G ( {u}^{( m )} )}{\vert ∇ G ( {u}^{( m )} ) \vert} ] {α}^{( m )} \\ {α}^{( m )} = - \frac{∇ G ( {u}^{( m )} )}{\vert ∇ G ( {u}^{( m )} ) \vert} .\end{matrix} \qquad ( 6 )$$

The search is started with an initial point u⁽¹⁾, e.g., the origin, a new iteration point u⁽²⁾ is found using the recursion formula above and the process is repeated until convergence is achieved. Equations (1) and (2) are used to evaluate the function G(u) for a given u. The gradient of G(u) is calculated using the following equations, derived from Equations (1) and (2):

$$\begin{matrix}\frac{\partial G}{\partial {u}_{l}} = {\sum }_{i = 1}^{n} {N}_{i} \frac{d {c}_{i} ( {S}_{i} )}{{dS}_{i}} \frac{\partial {S}_{i}}{\partial {u}_{l}} , \\ \frac{\partial {S}_{i}}{\partial {u}_{l}} = {S}_{i} \sqrt{τ} {J}_{il}\end{matrix} \qquad ( 7 )$$

Thus calculation of the gradient of G(u) involves ‘delta’s for the derivative instruments in the portfolio. Deltas are normally available from option pricing models used in valuing derivative securities. Deltas are either calculated analytically, e.g., for European options, or numerically, e.g., for models based on binomial trees, finite-difference methods, etc. Numerically deltas are calculated by calling the pricing model twice with slightly different stock price values.

In the standard (brute-force) Monte-Carlo method, the portfolio loss is calculated for a number of randomly generated vectors in the u-space. In contrast, in the Reliability-VAR framework, the knowledge of “design point” is utilized to focus the computational efforts in the vicinity of the point that contributes most to the loss probability.

I.4 First-Order Reliability Method (FORM)

If the portfolio loss is a linear function of independent Gaussian risk factors U₁, U₂, . . . , Uₖ, the loss probability q in Equation (5) reduces to a simple expression:

q=Φ(−β) (8)

where β is the distance of the “design point” from the origin and Φ(.) is the standard Gaussian cumulative distribution function. In general, the portfolio loss is a non-linear function of the risk factors, u, in which case the expression Φ(−β) is only an approximation to the exact probability and is referred to as the first-order reliability method (FORM) approximation. In effect, FORM entails approximating the limit-state surface by a linear hyper-plane, which is tangential to the limit-state surface at the design point. The quality of the FORM approximation depends on the curvatures of the limit-state surface at the design point. In the numerical examples presented in Section II, the error of FORM approximation was found to be in the range of 2%-4% for non-exceedance levels in the range of 10⁻⁵ to 10⁻¹. The FORM approximation error decreases for lower probability levels because the limit-state surface becomes flatter, which reduces the error due to the linear approximation.

Even for complicated limit-state functions, it usually takes only a few iterations (5-50) for the algorithm in Equation (6) to find the design-point. The FORM estimate is calculated easily by Equation (8). Hence, a FORM calculation involves only a few evaluations of the payoff function and its gradient. Note that the design point determination and the subsequent FORM estimation are repeated for a number of selected loss thresholds.

I.5 Second-Order Reliability Method (SORM).

In SORM, the non-linear limit-state surface is approximated by a second-order surface fitted at the design point (see FIG. 1). In one embodiment, a parabolic surface is constructed by matching the curvatures of the limit-state surface at the design point according to the following procedure.

1. Calculate the Matrix M of second derivatives

$$\frac{{\partial }^{2} G ( u )}{\partial {u}_{i} \partial {u}_{j}} {\vert}_{u = {u}^{*}}$$

at the design point.

2. Rotate the k-dimensional u-space coordinate system to obtain a new co-ordinate system such that one of its axes (say the k^{th}) coincides with the vectors u* and a (see FIG. 1). The rotation is achieved through a linear transformation of the form: U′=R U, where R is an orthogonal matrix with a as its last row. We use the Gramm-Schmidt orthogonalization scheme to find the remaining rows of the Matrix R. In the rotated coordinate system the fitted paraboloid is of the form:

$${u}_{k}^{′} = β + \frac{1}{2} {u}^{′ T} {Au}^{′} ,$$

where u′={u₁′, u₁′, . . . u′ₖ₋₁}^{T} and A=[aᵢⱼ]₍ₖ₋₁₎ₓ₍ₖ₋₁₎

3. The elements of Matrix A are obtained from the second-derivatives matrix M in the new co-ordinate system:

$${a}_{ij} = \frac{{( {RMR}^{T} )}_{ij}}{\vert ∇ G ( {u}^{*} ) \vert}$$

where i, j=1, 2 . . . k−1

4. Factorize (e.g., using Jacobi decomposition) the transformed matrix A. Eigenvalues of the transformed matrix A are the main curvatures of the limit-state surface at the design point.

5. Estimate the loss probability using a 1983 SORM formula by Tvedt (described on Page 67 of the 1986 book, “Methods of Structural Safety” by H. O. Madsen, S. Krenk, and N. C. Lind) that utilizes the main curvatures of the fitted parabolic surface calculated in Step 4 above.

In another embodiment, the second-order correction is be calculated by combining the knowledge of “design point” with the Analytical VAR methodology. If the limit-state surface is non-linear but sufficiently smooth, it is approximated by a quadratic function at the design point. The standard implementation of Analytical VAR as described by D. Duffie and J. Pan in their paper “Analytical Value-At-Risk with Jumps and Credit Risk,” uses delta-gamma sensitivities of the portfolio evaluated for the current market prices, i.e. at the origin of the standard Gaussian space. For highly non-linear portfolios, the accuracy of Analytical VAR estimation can be considerably increased by using delta-gamma sensitivities calculated at the design point instead of those at the origin. In contrast, a portfolio payoff function based on design-point delta gamma sensitivities as used in the Reliability VAR framework is more accurate in the region of interest, i.e., which contributes most to the integral in Equation (5). The accuracy is gained at expense of additional computational efforts in locating the design point, which is minimal. Note that the design point determination and the subsequent SORM or design-point Analytical VAR calculations are repeated for a number of selected loss threshold values.

The number of operations to perform curvature-fitted SORM or Analytical VAR (standard or design-point) calculation grows as k³. For a large number of risk factors (k>100) the computer time needed to calculate SORM significantly exceeds the time spent in locating the design point. Some SORM approaches, e.g., the point-fitted parabolic-surface approximation, are available that are less burdensome for problems with a large number of risk factors. For a portfolio with a large number of risk factors, the Reliability VAR framework calls for using a design-point based Importance Sampling strategy instead of using curvature-fitted SORM or design-point Analytical VAR.

I.6 Design-Point Importance Sampling

In a design-point importance sampling, the knowledge of the design point is exploited to increase the efficiency of Monte-Carlo Simulation. The probability integral in Equation (5) can be written as follows in terms of Ψ(u), a new sampling density function, and I(u), an indicator function, which is 1 if dΠ>0 and 0 otherwise:

$$q = {\int }_{G ( u ) < v} {φ}_{U} ( u ) ⅆ u = {\int }_{{R}^{k}} I ( u ) {φ}_{U} ( u ) ⅆ u = {\int }_{{R}^{k}} [ I ( u ) \frac{{φ}_{U} ( u )}{ψ ( u )} ] ψ ( u ) ⅆ u \qquad ( 8 )$$

and the loss probability is estimated from:

$$\hat{q} = \frac{1}{N} {\sum }_{j = 1 }^{k } I ( {u}^{( j )} ) \frac{{φ}_{U} ( {u}^{( j )} )}{ψ ( {u}^{( j )} )} , \qquad ( 9 )$$

where u^{(j)}'s are N independent samples drawn using the sampling density Ψ(u).

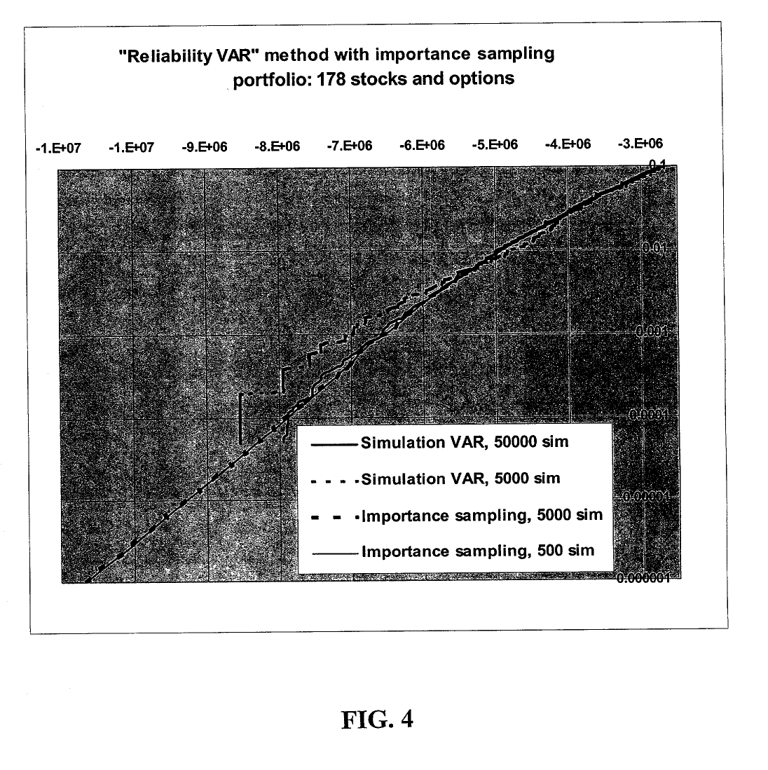

In a standard (brute-force) Monte Carlo method very few of the simulated outcomes represent loss events, which results in a large variance of estimation for the calculated loss probability. Importance sampling can be extremely efficient if the sampling density, Ψ(u), is properly chosen. In one embodiment, the mean of the sampling density function, a standard multi-normal density function, is shifted from the origin to the design point, whose neighborhood contributes the most to the loss probability integral in Equation (5). The design-point importance sampling procedure therefore requires finding the design point first and then simulating portfolio value changes using a sampling density that is focused around the design point. Importance sampling greatly improves the accuracy of Monte Carlo estimation as shown in FIG. 4.

I.7 Multiple Design Points

In majority of practical problems, there exists a single design point that affects the loss probability calculations. This implies that either there exists only a single design point, or even if multiple design points exist, one of them is much closer to the origin compared to the rest. It is however possible to construct artificial examples of limit-state equations having multiple design points (local minima) located at roughly comparable distances away from the origin in the standard Gaussian space.

In one embodiment, multiple design points are searched using an algorithm based on adding “bulges” to the G-function at the identified design point. This forces the search algorithm to look outside the vicinity of the design point that has been already identified. The probability contribution from the multiple design points, if found, is taken into account by computing the union of loss events as is common in series-system reliability analysis. Alternatively, one can use design-point importance sampling with a sampling density vt (u) equal to a weighted sum of the sampling density functions corresponding to the most important design points.

I.8 Extension of Reliability-VAR Framework to Treat Fat-Tailed Price Returns

To use the Reliability-VAR approach it is necessary to transform the random variables representing original price returns, X, into a set of standard Gaussian variates, U. As long as the portfolio payoff function can be expressed in terms of normally distributed price returns, which in general may be correlated, mapping of the failure surface to a standard Gaussian space requires only a simple transformation—a translation (to remove mean), scaling (to normalize standard deviation), and rotation (to remove correlation).

If the price returns are fat-tailed, their complete probabilistic description requires specification of a joint non-Gaussian distribution. In practice, a joint distribution function of all price returns is seldom available. In one embodiment, the inventive system and method uses a probability model for underlying price log-returns, specified (i) either by their marginal cumulative distribution functions or by their first few marginal moments and (ii) by the pair-wise linear correlations between them. The parameters of the probability models, e.g., volatility, correlation, other distribution parameters, etc., are calculated from market data of the most recent past, e.g., price returns of last sixty trading days, current price of underlying stocks and options, etc.

The transformation to the standard Gaussian space proceeds in two steps. The first step involves relating each of the price returns, Xᵢ, in general non-Gaussian, to a zero-mean unit standard-deviation Gaussian variable, Uᵢ, through a scalar (univariate) transformation, which is described next.

I.8.1 Scalar Transformation to the Standard Gaussian Space

A set of functional transformations of the form xᵢ=Tᵢ(uᵢ) is sought that relates each Xᵢ to Uᵢ, its Gaussian counterpart.

If the cumulative distribution function Fₓ (.) of a random variable X is known, the transformation from x-space to u-space can be written directly as:

x=T(^{u})=Fₓ⁻¹[Φ(u)], (10)

where Φ(.) is cumulative Gaussian distribution function.

Alternatively, if only the first four marginal moments of X of a leptokurtic (kurtosis coefficient, α₄>3) are given, a functional transformations x=T(u) is sought such that the four moments of X, mean μₓ, standard deviation σₓ, skewness coefficient α₃ₓ, and kurtosis coefficient by α₄ₓ, are preserved.

Following the treatment described in Winterstein, De, and Bjerager, 1989, the transformation is written in terms of orthogonal Hermite polynomial bases H(u)=[H₀(u), H₁(u), H₂(u), H₃(u) . . . ]^{T}=[1, u, (u²−1),(u³−3u), . . . ]^{T} and the first four moments of the leptokurtic (α₄>3) distribution as:

$$x = T ( u ) = {μ}_{x} + {κ}_{x} {σ}_{x} ⌊ u + {c}_{3 x} ( {u}^{2} - 1 ) + {c}_{4 x} ( {u}^{3} - 3 u ) ⌋ , where \\ {c}_{4 x} = [ \frac{\sqrt{6 {α}_{4 x} - 14} - 2}{36} ] , {c}_{3 x} = \frac{{α}_{3 x}}{6 ( 1 + 6 {c}_{4 x} )} , and \\ {κ}_{x} = \sqrt{1 + 2 {c}_{3 x}^{2} + 6 {c}_{4 x}^{2}} \qquad ( 11 )$$

The next step in the transformation process is to map the linear correlation from the original x-space to the u-space

I.8.2 Correlation Mapping from x- to u-Space

The scalar transformations described above map the price returns, Xᵢ's to a set of correlated Gaussian variates Uᵢ's. Let ρₓ be the correlation coefficient between the pair Xᵢ and Xⱼ and let the corresponding Gaussian variates be Uᵢ and Uⱼ, such that: xₖ=Tₖ(uₖ), where k=i, j.

In one embodiment, the “equivalent Gaussian correlation” ρᵤ (correlation between Uᵢ and Uⱼ) that produces the desired correlation, ρₓ, between the corresponding non-Gaussian random price returns, Xᵢ and Xⱼ, is estimated in closed form using a Hermite expansion method described below. The Hermite expansion based estimates are found to agree well (see Winterstein, De, and Bjerager, 1989) with exact results for ρᵤ, calculation of which require iterative use of double integration over the joint Gaussian density (Der Kiureghian and Liu, 1986).

Following the approach presented in Winterstein, De, and Bjerager, 1989, the transformations xᵢ=Tᵢ(uᵢ) and xⱼ=Tⱼ(uⱼ) are decomposed by a series of orthogonal bases associated with Hermite polynomials:

$$\begin{matrix}{x}_{i} = {T}_{i} ( {u}_{i} ) = {\sum }_{n = 0 }^{∞ } {t}_{i n} \frac{{H}_{n} ( {u}_{i} )}{\sqrt{n !}} , \\ {x}_{j} = {T}_{j} ( {u}_{j} ) = {\sum }_{n = 0 }^{∞ } {t}_{jn} \frac{{H}_{n} ( {u}_{j} )}{\sqrt{n !}}\end{matrix} \qquad ( 12 )$$

in which the coefficients tkn for k=i, j, . . . are given by:

$${t}_{kn} = E [ {T}_{k} ( {U}_{k} ) {H}_{n} ( {U}_{k} ) / \sqrt{n !} ] = \frac{1}{\sqrt{n !}} {\int }_{- ∞}^{∞} {T}_{k} ( {u}_{k} ) {H}_{n} ( {u}_{k} ) φ ( {u}_{k} ) ⅆ {u}_{k} \qquad ( 13 )$$

In these notations, E(Xᵢ)=tᵢ₀ and E(Xⱼ)=tⱼ₀. Coefficients tᵢₙ and tⱼₙ in Equation (12) are scalar products of the transformation function and the corresponding Hermite polynomial with weight φ, where φ(.) is a one-dimensional Gaussian probability density function.

A binormal probability density can be expressed in terms of Hermite polynomials as follows (Winterstein 1987):

$${φ}_{2} ( {u}_{i} , {u}_{j} , {ρ}_{u} ) = φ ( {u}_{i} ) φ ( {u}_{j} ) {\sum }_{n = 0}^{∞} \frac{{ρ}_{u}^{n}}{n !} {H}_{n} ( {u}_{i} ) {H}_{n} ( {u}_{j} ) \qquad ( 14 )$$

where φ(.) is the standard Gaussian density function. Hermite polynomials, Hₙ(U) for n=1,2,3, . . . have mean=0 and variance=n! and are uncorrelated (i.e., orthogonal) to each other. Hence Hₙ(U)/\sqrt{n!} has unit variance.

The covariance of Xᵢ and Xⱼ are expressed as follows:

$$COV [ {X}_{i} {X}_{j} ] = E [ {X}_{i} {X}_{j} ] - E [ {X}_{i} ] E [ {X}_{j} ] = {\int }_{- ∞}^{∞} {\int }_{- ∞}^{∞} {T}_{i} ( {u}_{i} ) {T}_{j} ( {u}_{j} ) {φ}_{2} ( {u}_{i} , {u}_{j} , {ρ}_{u} ) ⅆ {u}_{i} ⅆ {u}_{j} - {t}_{i0} {t}_{j0}$$

$$\begin{matrix} = {\int }_{- ∞}^{∞} {\int }_{- ∞}^{∞} {T}_{i} ( {u}_{i} ) {T}_{j} ( {u}_{j} ) φ ( {u}_{i} ) φ ( {u}_{j} ) {\sum }_{n = 0}^{∞} \frac{{ρ}_{u}^{n}}{n !} {H}_{n} ( {u}_{i} ) {H}_{n} ( {u}_{j} ) ⅆ {u}_{i} ⅆ {u}_{j} - {t}_{i0} {t}_{j0} \\ = {\sum }_{n = 0}^{∞} \frac{{ρ}_{u}^{n}}{n !} {\int }_{- ∞}^{∞} {T}_{i} ( {u}_{i} ) {H}_{n} ( {u}_{i} ) φ ( {u}_{i} ) ⅆ {u}_{i} {\int }_{- ∞}^{∞} {T}_{j} ( {u}_{j} ) {H}_{n} ( {u}_{j} ) φ ( {u}_{j} ) ⅆ {u}_{i} - {t}_{i0} {t}_{j0} \\ = {\sum }_{n = 0}^{∞} \frac{{ρ}_{u}^{n}}{n !} \sqrt{n !} {t}_{i n} \sqrt{n !} {t}_{jn} = {\sum }_{n = 1}^{∞} {ρ}_{u}^{n} {t}_{i n} {t}_{jn}\end{matrix}$$

Hence, the mapping relationship between the correlation in x- and u-space can be derived as follows:

$${ρ}_{{x}_{i} {x}_{j}} = \frac{COV [ {X}_{i} {X}_{j} ]}{{σ}_{{x}_{i}} {σ}_{{x}_{j}} x} = {\sum }_{n = 1}^{∞} \frac{{t}_{i n} {t}_{i n}}{{σ}_{{x}_{i}} {σ}_{{x}_{j}}} {ρ}_{u}^{n} , \qquad ( 15 )$$

where σₓᵢ and σₓⱼ are standard deviations of Xᵢ and Xⱼ respectively. Equation (15) is solved numerically. Usually a satisfactory estimate of ρᵤ is obtained by truncating the series at n=3 and inverting the resulting cubic equation.

Next, a covariance matrix for correlated Gaussian risk factors, U₁, U₂ . . . , Uₙ, is assembled from the pair-wise correlation coefficients, calculated using Equation (15). Following the standard linear algebraic procedure described in Section I.1, the covariance matrix is factorized and a linear transformation is derived for mapping the correlated Gaussian risk factors into standard Gaussian risk factors, which are uncorrelated. Thus it becomes possible to use FORM/SORM when one or more risk factors have non-Gaussian distributions.

The transformation to the standard-Gaussian space discussed above can also be used in conjunction with Monte Carlo Simulation and Analytical VAR methodology.

II. Implementation of VAR Calculation Using FORM/SORM

The present invention includes not only a computer-implemented method of determining Reliability VAR, but additionally a system including a computer and a program, database and software for execution of steps to determine Reliability VAR. Also, the invention encompasses computer media, such as a magnetic or optical media has computer-readable program code embodied therein for performing the steps of determining Reliability VAR and tail loss.

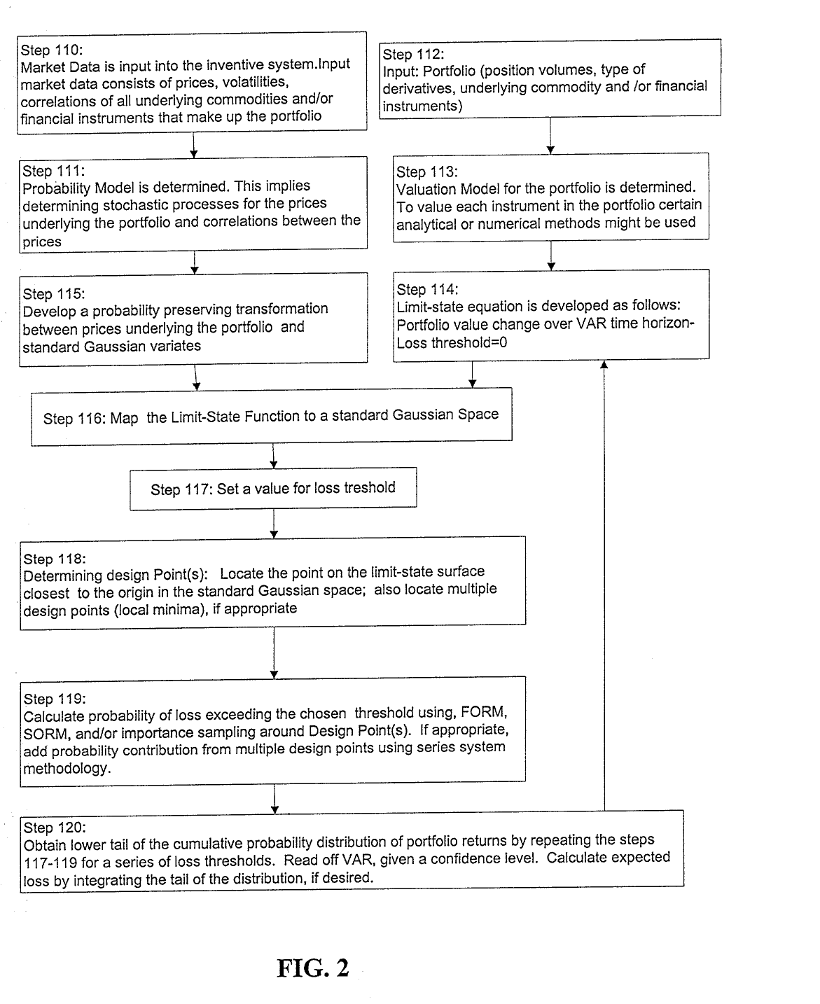

Referring to FIG. 2, a flow diagram describes the steps performed in Reliability VAR determination of the inventive method and system. In Step 110, market data is input into the inventive system. The market data may be collected from any variety of sources. Also, the input market data may be stored on a database, datasets, files or other known or useful data storage devices and may be input manually, or from data feeds using computer programs, or from other useful data storage devices. The input market data for VAR calculation consists of price, volatility, and correlation of all underlying commodities and/or financial instruments that make up the financial portfolio. The most-recently observed price data are used in the calculation. Volatility refers to the volatility of price return and can either be obtained indirectly form the most-recent price of the option on the underlying or by analyzing price-return historical data from the recent-past. Correlation refers to the correlation matrix of price returns obtained by jointly analyzing most-recent historical price-return data of all underlying commodities/instruments in the portfolio. Input market data described here are standard input to most traditional VAR calculation engines.

In Step 111, the probability distribution of the underlying instruments is determined. A number of different approaches are commonly used to develop probability distributions of underlying instruments. In the preferred embodiment, a stochastic process for price returns, e.g., Geometric Brownian Motion, is assumed which leads to the marginal probability distributions of the underlying instrument. The parameters of the marginal probability distribution are estimated from market data described in Step 110. Preferably, a joint distribution of all price returns of all underlying instruments is required. In practice, the probability model consists of marginal (scalar or one-dimensional) probability distribution of price return of each underlying instrument and the correlation matrix between price returns, as described in Step 110.

In Step 112, portfolio data is input into the inventive system. The portfolio data consists of all portfolio positions, i.e., volume, on each of the different types of derivatives instruments (e.g., stock, option, swap, swaption, etc.,) and the underlying commodity and/or financial instrument (e.g., stock, bond, interest rate, foreign-exchange rate, etc.) for each of the derivatives.

In Step 113, the portfolio valuation equation is determined. Utilizing standard portfolio valuation models, the inventive system and method set up an equation for calculating the value of the portfolio as a function of the price returns of underlying commodities and/or financial instruments, for which the probability model was developed in Step 111. For example, the valuation model for a position on a stock is simply the product of number of stocks in the portfolio and the variable representing the price of the stock. Similarly standard pricing algorithms may be utilized for valuing positions on financial derivatives (e.g., “Black-Scholes Equation” can be used for pricing options as a function of the price of the underlying stock). Portfolio valuation models are necessary for all VAR calculation schemes and they allow calculation of portfolio value change (loss) in Step 114.

In Step 114, a VAR limit-state equation is developed. In the present inventive system and method, the lower tail of return distribution is calculated by evaluating the probability of portfolio value change not exceeding a specified loss (negative portfolio value change) threshold and repeating the process for a number of loss thresholds. The VAR limit-state equation is defined as:

Portfolio value change over VAR time horizon−Loss threshold=0,

where the portfolio value change is determined by the known portfolio positions and the uncertain underlying prices returns, for which the probability model was developed in Step 111. Thus, the limit-state equation is determined as well.

In Step 115, a probability preserving transformation between stochastic price returns of stocks and commodities underlying the portfolio and standard Gaussian independent variates is developed. As discussed above in Step 111, the model for joint distribution of the prices underlying the portfolio is described by i) one dimensional cumulative probability distributions of price returns and ii) relationships, i.e, linear correlation between price returns. In the preferred embodiment, the desired probability preserving transformation is performed in steps A, B, and C.

Step A. Each price return Xᵢ is assumed as some unknown function of a scalar standard Gaussian variable Vᵢ: Xᵢ=Tᵢ(Vᵢ). The function Tᵢ(.) may be by found by either using Equation (10) (this is when the cumulative probability distribution of Xᵢ is known), or by using Equation (11) (this is when one knows only a few moments of the marginal probability distribution of Xᵢ).

Step B. Based on functions Tᵢ(Vᵢ) and Tⱼ(Vⱼ) for each pair of price return variables Xᵢ and Xⱼ, the correlation between Gaussian variates, Vᵢ and V_{y} is found such that the corresponding linear correlation between Tᵢ(Vᵢ) and Tⱼ(Vⱼ) is equal or approximately equal to the correlation between Xᵢ and Xᵢ. (see “Correlation Mapping” section). After the pair-wise correlations between Vᵢ and Vⱼ's are determined, the correlation matrix C for the vector of Gaussian variates V is assembled and checked for positive-definiteness.

Step C. In Steps A and B, a probability preserving transformation between the price returns Xᵢ and standard Gaussian correlated variables Vᵢ is developed. Next, a linear transformation of the form V=J U is sought, where U is the vector of standard uncorrelated Gaussian variates corresponding to V. The matrix J is obtained through Jacobi decomposition of the correlation matrix C as described in Section I. 1. Using Jacobi decomposition, the inventive system and method calculates matrix F of eigenvectors of matrix C and matrix L of eigenvalues of matrix C, such that C=J*J^{T}, where J=F*L^{0.5}. If the matrix C is not positive definite to start with, some of its eigenvalues will be negative. The columns of matrix F corresponding to negative eigenvalues are eliminated, and the present inventive system and method calculates matrix J1 based on remaining eigenvalues. The matrix J1 is then scaled with a diagonal matrix D such that D*J1*J1^{T}*D=C. In most practical cases, C does not have negative eigenvalues due to the fact that the original correlation matrix across Xᵢ is positive definite and usually the marginal distributions of price returns are similar to Gaussian distributions. In rare cases, when negative eigenvalues occur, it is possible to calculate matrices J1 and D. In such a case, the transformation developed will only approximately preserve the original (x-space) correlation relationships. This approximation is of little concern, since to start with the use of a correlation matrix does not completely describe joint distribution of non-Gaussian price returns.

In Step 116, the inventive system and method maps the limit-state equation to a standard Gaussian space, i.e., recast the limit-state equation in terms of standard Gaussian variates using the transformation between uncertain price returns and the standard Gaussian variates, developed in Step 115. The limit-state equation expressed in terms of the standard Gaussian variates defines a limit-state surface in the standard Gaussian space.

In step 117 the loss threshold is determined. “Variance-Covariance” method is used to estimate a standard deviation of portfolio value change based on “delta” sensitivities of the underlying options, current market prices, volatilities and correlation. A range from minus 5 standard deviations to minus 1 standard deviation is specified. 100 equally spaced (in logarithmic scale) points are set. A loss threshold is set to be one of these points.

In Step 118, the inventive system and method determine design point, a point on the limit-state surface closest to the origin of the standard Gaussian space. In one embodiment, a simple iterative procedure is used to calculate the coordinates of the “design point” using Equation (6), which is based on the fact that at the “design point” u* the gradient of the limit-state function G(u*) is collinear with vector u*. Even for complicated limit-state functions, it usually takes only a few iterations to converge to a solution for the design point.

In Step 118 the inventive system and method also searches for multiple design points. In one embodiment, multiple design points are searched using an algorithm based on adding “bulges” to the G-function at the identified design point. This forces the search algorithm to look outside the vicinity of the design point that has been already identified.

In Step 119, the inventive system and method calculates the loss probability, i.e., probability of the portfolio value-change not exceeding the specified portfolio loss (negative portfolio value-change) threshold. The inventive system and method perform Step A, B, and C.

Step A. Calculation of First Order Reliability Approximation (FORM). FORM estimation is trivial once the design point is known, and is calculated as Φ(−β), where β is the distance of the “design point” from the origin in the standard Gaussian space and Φ(.) is the standard Gaussian cumulative distribution function. Hence FORM approximation requires only a few evaluations of the portfolio payoff function and its gradient.

Step B. Calculation of Second Order reliability Approximation (SORM). In second-order reliability method (SORM), the limit-state surface in the standard Gaussian space is approximated by a second-order hyper-surface fitted at the “design point” and the loss probability is approximated as the probability of the loss region bounded by the approximated second-order surface.

In one embodiment, a parabolic surface is constructed by matching the main curvatures of the limit-state surface at the design point as described in Section I.5. Using the estimated main curvatures, the probability of loss is estimated from a 1983 SORM formula by Tvedt, described on Page 67 of the 1986 book, “Methods of Structural Safety” by H. O. Madsen, S. Krenk, and N. C. Lind

In another embodiment, the second-order correction is be calculated by combining the knowledge of “design point” with the Analytical VAR methodology. If the limit-state surface is non-linear but sufficiently smooth, it is approximated by a quadratic function at the design point. For highly non-linear portfolios, the accuracy of the standard Analytical VAR estimation, which uses delta-gamma sensitivities of the portfolio at the current market price, can be considerably increased by using delta-gamma sensitivities calculated at the design point instead of those at the origin. The accuracy is gained at expense of additional computational efforts in locating the design point, which is minimal.

Note that the design point determination and the subsequent SORM or design-point Analytical VAR calculations are repeated for a number of selected loss threshold values

Step C. Add probability contribution from multiple “design points”, if they exist, by computing the probability of union of loss events as is common in series-system reliability analysis.

For a portfolio with a large number of underlying price returns, it may be more efficient to use a design-point based importance sampling for estimating the loss probability. In this case alternatively to Steps B and C, utilize Steps B-1 and C-1:

Step B-1. Use importance sampling based on the knowledge of the design points. In one embodiment, the mean of the Monte Carlo sampling density function, a standard multi-normal density function, is shifted from the origin to the design point. The design-point importance sampling procedure therefore requires finding the design point first and then simulating portfolio value changes using a sampling density that is focused around the design point. Importance sampling will greatly improve the accuracy of the estimated loss probability over the standard brute-force Monte Carlo simulation.

Step C-1. For multiple design points, if they exist, use importance sampling with a sampling density Ψ(u) equal to a weighted sum of the sampling density functions corresponding to the most important design points.

In Step 120, Steps 117 through 119 are repeated for a range of loss threshold values so as to obtain the portfolio value change probability distribution values in the range of non-exceedance levels 10⁻⁵ to 10⁻¹. VAR and other desired of the portfolio value-change quantiles are read off the calculated tail of the probability distribution. The expected loss beyond VAR or other useful risk analytics can be calculated by numerically integrating the tail of the distribution beyond the VAR value.

III. Exemplary Cases

The following cases demonstrate the advantages of using the inventive system and method with respect to speed and accuracy over standard methods used in the financial community.

A. Case 1. Equity Portfolio of 178 Stocks and Options.

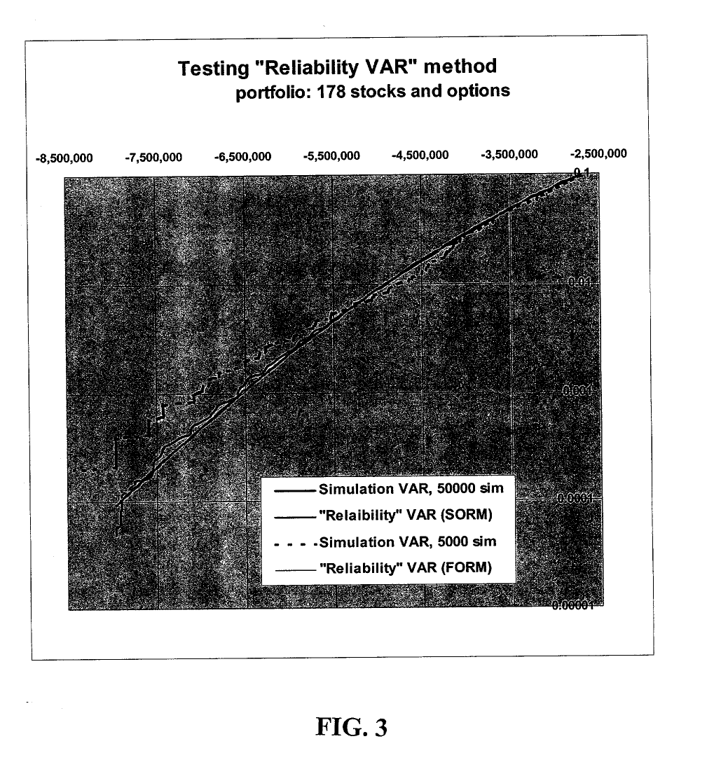

Referring to FIG. 3, a plot is shown displaying the tail of the distribution of daily change in the portfolio value using first- and second-order reliability methods is determined for an equity portfolio of 178 stocks and options. The portfolio consists mostly of stock positions, but it also includes European and American options. Although the SORM results on the plot overlap the FORM results, the SORM results in this case imply a correction in the range of 3.8%-1.5% to the FORM results. Monte-Carlo simulations with 5,000 samples produce a wiggly distribution function, while Monte Carlo simulations with 50,000 samples achieve decent accuracy for lower probability levels. Finding the first design point followed by a FORM estimate of probability without the curvature correction is very fast and sufficiently accurate for most real-life portfolios.

Now referring FIG. 4, a plot is shown displaying the results of standard brute-force Monte-Carlo simulations with that from the design-point importance sampling for the same portfolio. The design point corresponding to a loss probability equal to 10⁻¹ is used for importance sampling. A standard multi-normal vectors with the mean equal to this design point is drawn repeatedly. The tail of the distribution is calculated for 500 and 5000 simulations. The number of simulations required to calculate the tail of the distribution with comparable accuracy is a few orders less compared to standard Monte-Carlo technique.

B. Case 2. Hedged Portfolio of Stocks and Options.

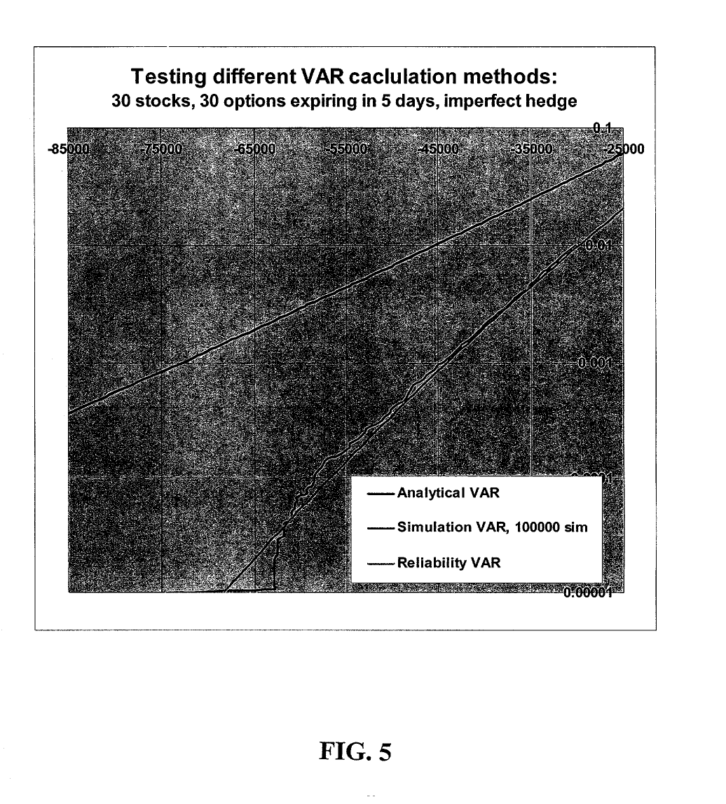

Referring to FIG. 5, a plot is shown comparing results from different VAR calculation methods for a portfolio with a highly non-linear payoff function, where the delta-gamma representation is clearly inadequate. Such is the case for a portfolio with hedged instruments. Hence VAR results based on linear approximation of the failure surface (e.g., using FORM) as well as results based on delta-gamma representation of the payoff function (e.g., using standard Analytic VAR, SORM or Monte Carlo) are expected to be quite different from that obtained from a large number of Monte Carlo simulation of portfolio returns with full options revaluation for each set of simulated price.

The portfolio considered in this example case, consists of 30 options and 30 stocks, paired to hedge each other. The 60 underlying stock prices are assumed to be distributed lognormally. The correlations between the stocks are assumed to be of the form:

$${ρ}_{ij} = \frac{1}{1 + 0.02 \vert i - j \vert}$$

The options are assumed to be at-the-money American and European options, expiring in 5 days. The volatilities range from 20% to 110%. For each stock and option pair, the number of stock shares is chosen to approximately hedge the corresponding option position. The portfolio contains 1000 shares of options on stocks number 1, 3, 5, . . . , 59 and 550 shares of stocks number 2, 4, 6, . . . , 60. Such a portfolio has positions with very high gammas.

Referring to FIG. 5, a chart is shown displaying the tail of probability distribution for the exemplary portfolio calculated by three different methods: standard Monte-Carlo simulation, standard Analytical VAR and FORM/SORM (Reliability VAR). In this example, the accurate calculation with FORM/SORM method requires finding two closest design points and using SORM approximations at the design points. Reliability VAR results match the simulation results very well in spite of the SORM approximation, presumably because the SORM approximation is carried out at the design point, whose neighborhood contributes the most to the loss probability

As expected, the Analytical VAR results, which are based on delta-gamma representation of the portfolio positions at the current price, are very different from full-revaluation Monte-Carlo and FORM/SORM results.

Monte-Carlo requires many simulations to accurately estimate the tail of the distribution. In this example we used 100,000 simulations and the results are in a good agreement for percentiles p greater than 0.08%. For p<0.08% the accuracy of Monte-Carlo method is not sufficient. The time expenditures are 20 sec. for Analytical VAR, 35 sec for Reliability VAR and 55 sec for Monte-Carlo on a Pentium III, 850 MHz, desktop computer. In this case, the accurate calculation with FORM/SORM method requires finding two closest design points and calculating second-order approximation at design points.

C. Case 3. Matching Four Moments of Marginal Distributions and Correlations Across Underlying Stocks with “Fat-Tailed” Return Distribution.

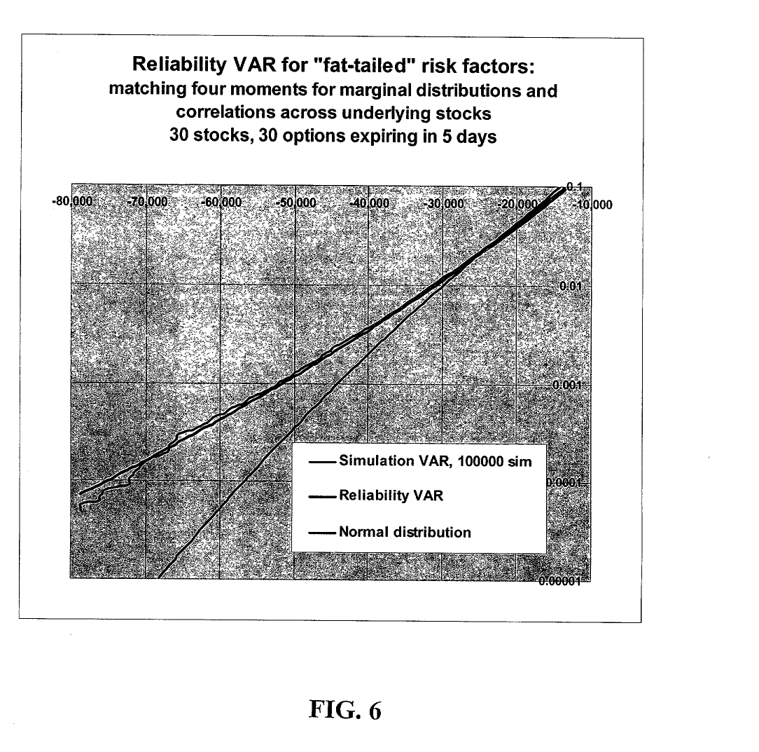

In this case, the portfolio of the same 30 stock-option pairs described in the preceding section is considered again. A further assumption is made that the marginal distributions of stock log-returns have equal skewness coefficient of 0 and equal kurtosis coefficients of 4, which implies that the price return distributions are “fat tailed.” Following the approach outlined in Section I.8, the probability estimation problem is mapped to the standard Gaussian space. Referring to FIG. 6, a plot is shown displaying the tail of distribution of portfolio returns, calculated using FORM/SORM (Reliability VAR) and standard (brute-force) Monte-Carlo simulations with 100,000 samples. For Monte-Carlo simulations, the transformation used in Reliability VAR is used to simulate log-returns with prescribed marginal moments and pair-wise correlations. The distribution results for Gaussian log-returns having the same means, standard deviations, and pair-wise correlations between them as the non-Gaussian variables are also shown in FIG. 6. As expected for lower non-exceedance thresholds the two distributions diverge. The computational expense for the fat-tailed price return case is not any higher than that for the portfolio with Gaussian price returns

Moreover, the embodiments described are further intended to explain the best modes for practicing the invention, and to enable others skilled in the art to utilize the invention in such, or other, embodiments and with various modifications required by the particular applications or uses of the present invention. It is intended that the appending claims be construed to included alternative embodiments to the extent that it is permitted by the prior art.

What is claimed is:

1. A computer-implemented method for determining Value-at-Risk (VAR), said method comprising the steps of:
(a) determining a probability preserving transformation between a set of correlated price returns of one or more financial instruments and of standard Gaussian variates using a probability model;
(b) creating a set of loss threshold values at which a lower tail of a probability distribution of portfolio value change is to be evaluated;
(c) selecting a value from the set of loss threshold values;
(d) determining a limit-state surface on which the portfolio value change is equal to the selected loss threshold value of step (c) by expressing a limit-state-equation in terms of one or more standard Gaussian variates using the probability preserving transformation calculated in step (a);
(e) finding one or more design points on the limit-state surface closest to an origin of a standard Gaussian space;
(f) calculating a probability of portfolio value change not exceeding the selected loss threshold value using one or more methods from the group consisting of (First-Order Reliability Method, Second-Order Reliability Method, or importance sampling around the one or more design points);
(g) repeating Steps (c) through (f) for each selected loss threshold value of step (b), whereby a lower tail of the cumulative probability distribution of portfolio value change is created; and
(h) determining a Value-at-Risk as a desired quantile of the lower tail of the cumulative probability distribution of portfolio value change.

2. The computer-implemented method of claim 1, further comprising the step of calculating expected tail loss by integrating the lower tail of the cumulative probability distribution of portfolio value change beyond the desired quantile.

3. The computer-implemented method of claim 1, wherein the probability model includes using Stochastic differential equations describing fluctuations of market prices with time leading to the probability distribution of price returns.

4. The computer-implemented method of claim 1, wherein the calculating a probability preserving transformation step (a) includes: deriving a set of scalar equations that relates each of the price returns, in general non-Gaussian, to a set of Gaussian variates and calculating the correlations between the Gaussian variates from linear correlations between the price returns.

5. The computer-implemented method of claim 1, further comprising setting up a pricing model for each derivative position in the portfolio whereby the portfolio value is calculated as a function of price of the underlying instrument.

6. The computer-implemented method of claim 5 wherein the pricing model is selected from the group consisting of: the Black-Scholes model for European options, or Lattice or Finite-Difference model for American options.

8. A system for determining Value-at-Risk (VAR), said system comprising of:
a computer; and
a software program being executable by the computer, the software program for executing the steps:
(a) determining a probability preserving transformation between a set of correlated price returns of one or more financial instruments and of standard Gaussian variates using a probability model;
(b) creating a set of loss threshold values at which a lower tail of a probability distribution of portfolio value change is to be evaluated;
(c) selecting a value from the set of loss threshold values;
(d) determining a limit-state surface on which the portfolio value change is equal to the selected loss threshold value of step (c) by expressing a limit-state-equation in terms of one or more standard Gaussian variates using the probability preserving transformation calculated in step (a);
(e) finding one or more design points on the limit-state surface closest to an origin of a standard Gaussian space;
(f) calculating a probability of portfolio value change not exceeding the selected loss threshold value using one or more methods from the group consisting of (First-Order Reliability Method, Second-Order Reliability Method, or importance sampling around the one or more design points);
(g) repeating steps (c) through (f) for each selected loss threshold value of step (b), whereby a lower tail of the cumulative probability distribution of portfolio value change is created; and
(h) determining a Value-at-Risk as a desired quantile of the lower tail of the cumulative probability distribution of portfolio value change.

9. The system of claim 8, further comprising:
a market data database for storing and retrieving a set of market data for one or more financial instruments, the market data database being accessible by the computer, and
a portfolio database for storing and retrieving a set of portfolio data of financial derivatives, the portfolio database being accessible by the computer.

10. A computer-usable medium having computer-readable program code embodied therein for causing a computer to perform the steps of:
(a) determining a probability preserving transformation between a set of correlated price returns of one or more financial instruments and of standard Gaussian variates using a probability model;
(b) creating a set of loss threshold values at which a lower tail of a probability distribution of portfolio value change is to be evaluated;
(c) selecting a value from the set of loss threshold values;
(d) determining a limit-state surface on which the portfolio value change is equal to the selected loss threshold value of step (c) by expressing a limit-state-equation in terms of one or more standard Gaussian variates using the probability preserving transformation calculated in step (a);
(e) finding one or more design points on the limit-state surface closest to an origin of a standard Gaussian space;
(f) calculating a probability of portfolio value change not exceeding the selected loss threshold value using one or more methods from the group consisting of (First-Order Reliability Method, Second-Order Reliability Method, or importance sampling around the one or more design points);
(g) repeating Steps (c) through (f) for each selected loss threshold value of step (b), whereby a lower tail of the cumulative probability distribution of portfolio value change is created; and
(h) determining a Value-at-Risk as a desired quantile of the lower tail of the cumulative probability distribution of portfolio value change.

11. The computer-usable medium of claim 10, further having computer-readable program code embodied therein for causing a computer to perform the step of calculating expected tail loss by integrating the lower tail of the cumulative probability distribution of portfolio value change beyond the desired quantile.
